(19) United States
(12) Patent Application Publication
(10) Pub. No.: US 2007/0294400 A1
(43) Pub. Date: Dec. 20, 2007

(54) CONTROL SYSTEM

(75) Inventor: Yuichi Sakuraba, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 11/761,424

(22) Filed: Jun. 12, 2007

(30) Foreign Application Priority Data
Jun. 16, 2006 (JP) 2006-167317

(51) Int. Cl. G06F 15/173

(52) U.S. Cl. 709/224

(57) ABSTRACT

Disclosed a control system 1 performing, through an HTTP communication, a communication between a client terminal 10 that remotely performs an operation instruction and a controller 20 related to a control/monitoring for an equipment, passing the instruction, which goes from the client terminal 10 to the controller 20, through a CGI message interpretation section 23, and outputting data such as monitoring information of the equipment, which goes from the controller 20 to the client terminal 10, as an XML message.

### BACKGROUND OF THE INVENTION

1. Field of the Invention

The present invention relates to a control system in which a controller of an industrial plant or the like is controlled from a terminal.

2. Description of Related Art

Heretofore, in a control system of an industrial plant or the like, controllers placed in the respective sections of the plant have been monitored/controlled remotely by a client terminal, such as a personal computer (PC) and a work station (WS), which is communicably connected to the controllers.

For example, FIG. 3A shows a configuration of a control system 100 of earlier development. The control system 100 includes a client terminal 110 and a controller 120, which communicate with each other through a dedicated protocol. The client terminal 110 executes a dedicated management application program to thereby control or instruct the controller 120 and manage the status thereof by a communication through the dedicated protocol. The controller 120 includes a control section 121 that controls the respective sections, a dedicated protocol interpretation section 122 that interprets the dedicated protocol transmitted from the client terminal 110 and outputs the dedicated protocol to the control section 121, and a dedicated protocol response generation section 123 that generates a dedicated protocol for responding to the client terminal 110 based on an instruction from the control section 121.

With the foregoing configuration, the control system 100 controls an open/close drive of a regulation valve (not particularly shown) by the controller 120 in response to an instruction from the client terminal 110, and outputs measurement data in the controller 120 measured by a sensor (not particularly shown) to the client terminal 110 by a communication through the dedicated protocol.

Moreover, FIG. 3B shows a configuration of a control system 200 in earlier development. The control system 200 includes a client terminal 210 and a controller 220, which communicate with each other through Hypertext Transfer Protocol (HTTP). The client terminal 210 controls or instructs the controller 220 or manages the status thereof through an HTTP communication using a Web browser or the like. The controller 220 includes a control section 221 that controls the respective sections, a Common Gateway Interface (CGI) message interpretation section 222 that interprets the HTTP communication transmitted from the client terminal 210 and issues an instruction to allow the control section 221 to execute a predetermined control/management program, and a HyperText Markup Language (HTML) document generation section 223 that generates an HTML document to be sent back to the client terminal 210 based on an execution result of the control/management program in the control section 221 and the like.

With the foregoing configuration, the control system 200 controls the open/close drive of the regulation valve (not particularly shown) by the controller 220 through the HTTP communication, and outputs the measurement data in the controller 220 measured by the sensor (not particularly shown) to the client terminal 210 as the HTML document (a Web page) using the HTTP communication.

Moreover, FIG. 3C shows a configuration of a control system 300 in earlier development. The control system 300 includes a client terminal 310 and a controller 320, which communicate with each other through an HTTP communication using Simple Object Access Protocol (SOAP). The client terminal 310 controls or instructs the controller 320 and manages the status thereof through an HTTP communication using the SOAP included in a Web browser or the like having a plug-in such as JavaApplet. The controller 320 includes a control section 321 that controls the respective sections, a SOAP message interpretation section 322 that interprets the SOAP transmitted from the client terminal 310 and outputs an instruction regarding a control/management program to be executed in the control section 321, and a SOAP message generation section 323 that generates a message according to the SOAP, which is to be sent back to the client terminal 310, based on an execution result of the control/management program in the control section 321.

With the foregoing configuration, the control system 300 controls the open/close drive of the regulation valve (not particularly shown) by the controller 320 in response to an instruction from the client terminal 310 through the HTTP communication using the SOAP, and outputs the measurement data in the controller 320 measured by the sensor (not particularly) shown) to the client terminal 310 through the HTTP communication using the SOAP. Such control of the controller, which uses the SOAP, is also disclosed in Japanese Patent Application Laid-open Publication No. 2002-223211.

However, such earlier development as described above have had problems as below. The control system 100 uses the dedicated communication protocol, and the client terminal uses the dedicated application to perform the control/monitor of equipments connected to the controller 120. Consequently, versatility of the control system 100 is low. Moreover, in the control system 100, the communication protocol is a dedicated one (special one). Consequently, when the communication between the client terminal 110 and the controller 120 is performed across a firewall, it is necessary to set the firewall to allow passing of the dedicated protocol. However, such setting may cause security vulnerability of the control system.

Moreover, the control system 200 as shown in FIG. 3B is a system used in Business to Consumer (B to C: B2C) commerce and the like, and a security techniques for the Web, and the like can be directly applied thereto. However, since the information is updated for each page of the browser, it is necessary for the controller 220 to also transmit other data than monitoring data for the purpose of constructing the page, and thereby the traffic is increased. Such a disadvantage is particularly problematic when the information is updated frequently. Moreover, also on the client terminal 210 side, the entirety of the page is rendered highly frequently. Consequently, a problem of flicker or the like occurs.

Furthermore, in the control system 300 as shown in FIG. 3C, the SOAP is used as the communication protocol, and the SOAP is composed of the extensible Markup Language (XML). Consequently, the Remote Procedure Cell (RPC) for the controller 320 can be used. However, a schema of the SOAP is also redundant, where it is difficult to reduce the traffic. Moreover, parsing of the SOAP is complicated, which becomes high-load processing for the controller 320 whose resources are limited, such as a processing capability of a central processing unit (CPU) and a memory. Consequently, control processing for the plant, which is a main task of the controller 320, is sometimes affected. Moreover, in order to use the SOAP, it is necessary to separately install a plug-in such as the JavaApplet also in the Web browser of the client terminal 310. Therefore, versatility is not so high.

### SUMMARY OF THE INVENTION

The present invention has been made in consideration for the problems of the earlier development. It is an object of the present invention to provide a control system that suppresses consumption of the resources for the communication and the system and has high versatility.

In order to accomplish the above object, in accordance with a first aspect of the invention, a control system includes: a controller to control an equipment connected thereto and/or to output monitoring information of the equipment based on an inputted control instruction; and a client terminal to control the equipment connected to the controller by outputting the control instruction to the controller and/or to monitor the equipment connected to the controller based on the monitoring information outputted from the controller, the client terminal being communicably connected to the controller, wherein the client terminal includes: a Web browser processing section to perform a communication with the controller through an HTTP communication, the communication being related to the control and/or monitoring of the equipment, and the controller includes: a CGI message interpretation section to output the control instruction for the equipment and/or an output instruction for the monitoring information to a control section which controls and/or monitors the equipment, the control instruction and the output instruction being included in the HTTP communication from the client terminal; and an XML message generation section to generate an XML message including the monitoring information of the equipment, the monitoring information being acquired by the control section, and to output the XML message to the client terminal through the HTTP communication.

Preferably, the Web browser processing section of the client terminal issues, as an HTTP command, the communication related to the control and/or the monitoring of the equipment in the HTTP communication with the controller, and the CGI message interpretation section of the controller outputs the control instruction for the equipment and/or the output instruction for the monitoring information to the control section, based on the HTTP command.

Preferably, the Web browser processing section of the client terminal includes a Web browser communication section, and a Web browser rendering section, the Web browser communication section performs the HTTP communication with the controller, and the Web browser rendering section renders, on a display section, an image based on an HTML document related to the control and/or monitoring of the equipment and/or on the XML message from the controller, the XML message being received by the browser communication section.

Preferably, based on a script language of the HTML document and/or on a program module, the Web browser rendering section of the client terminal instructs the controller to output the XML message so that the XML message is acquired through the Web browser communication section.

In accordance with the invention, the control system includes: a controller to control an equipment connected thereto and/or to output monitoring information of the equipment based on an inputted control instruction; and a client terminal to control the equipment connected to the controller by outputting the control instruction to the controller and/or to monitor the equipment connected to the controller based on the monitoring information outputted from the controller, the client terminal being communicably connected to the controller. In the control system, the communication between the client terminal and the controller can be performed through the HTTP communication, the control instruction for the equipment and/or the output instruction for the monitoring information can be sent from the client terminal to the controller through the HTTP communication, and the monitoring information can be outputted from the controller to the client terminal as the XML message. Consequently, the control system can be provided with the high versatility through the HTTP communication, and can suppress the consumption of the resources for the communication and the system by using the XML message.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1A is a conceptual view schematically showing a functional configuration of a control system 1 as the present invention;

FIG. 1B is a conceptual view schematically showing a functional configuration of a control system 1a;

FIG. 2 is a ladder chart showing processing of the control system 1;

FIG. 3A is a conceptual view showing a configuration of a control system 100 of earlier development;

FIG. 3B is a conceptual view showing a configuration of a control system 200 of earlier development;

FIG. 3C is a conceptual view showing a configuration of a control system 300 of earlier development.

### DETAILED DESCRIPTION OF THE INVENTION

An embodiment of the present invention will be described with reference to the drawings. However, the present invention is not limited to the following embodiment. Moreover, this embodiment of the present invention illustrates the most preferred mode of the invention, and purposes and terms of the invention are not limited to this embodiment.

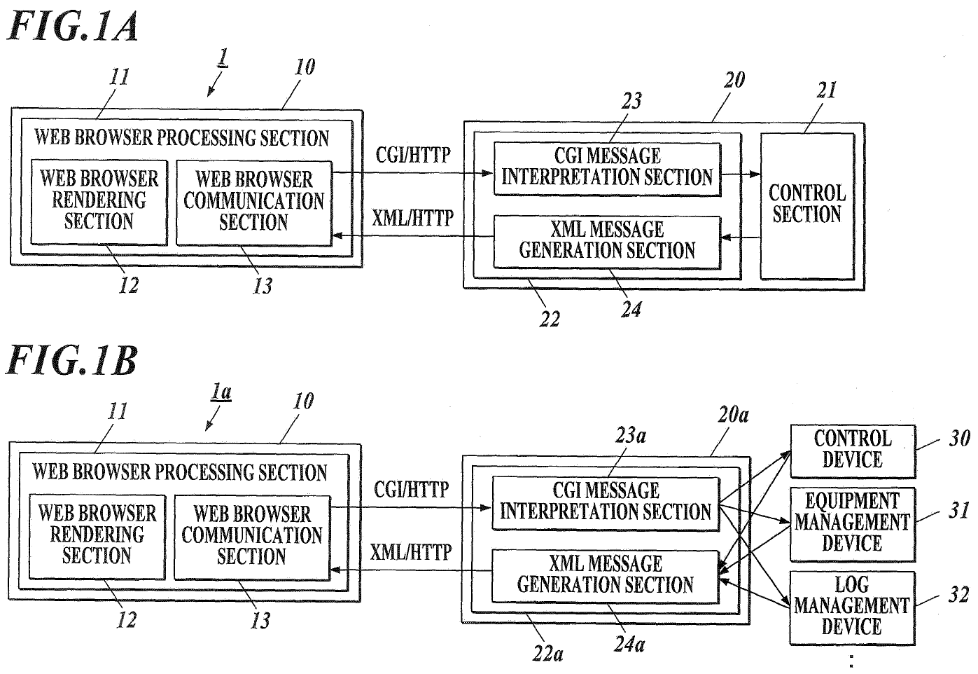

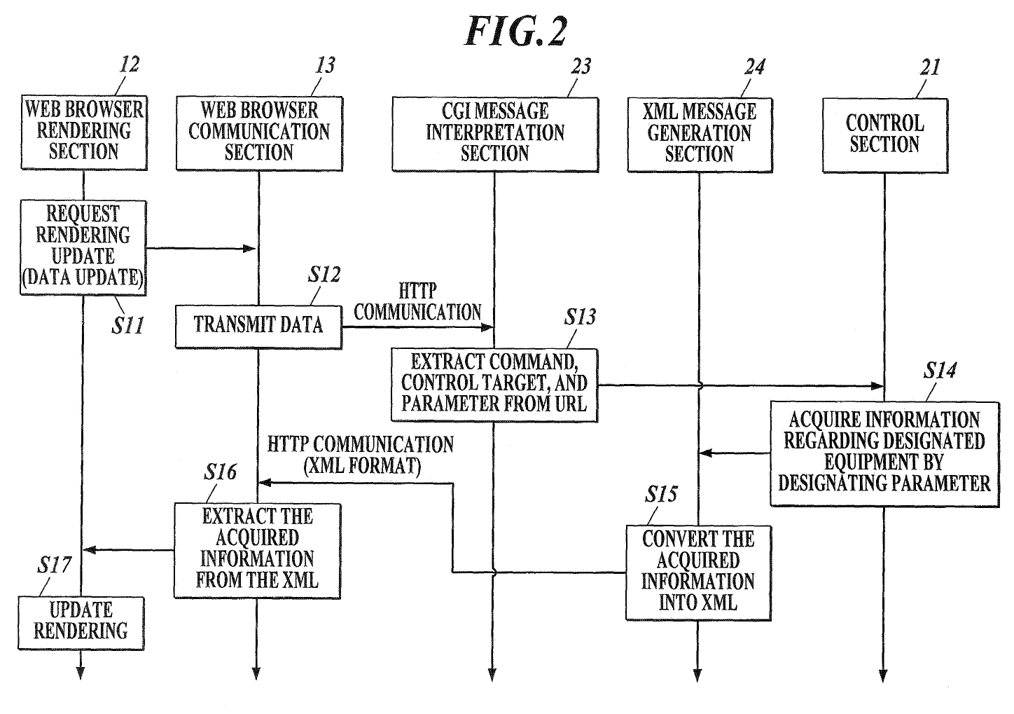

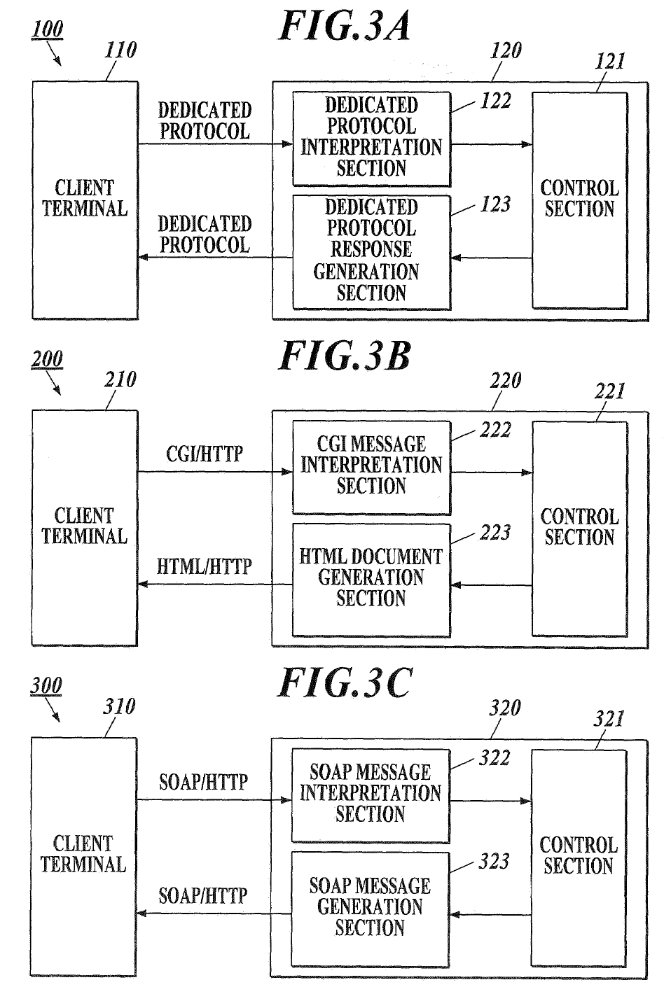

FIG. 1A is a conceptual view schematically showing a functional configuration of a control system 1 as the present invention. FIG. 1B is a conceptual view schematically showing a functional configuration of a control system 1a. FIG. 2 is a ladder chart showing processing of the control system 1.

First, the configuration of the control system 1 will be described. As shown in FIG. 1A, the control system 1 includes a client terminal 10 and a controller 20, which are connected to each other through a wired or wireless communication network (not particularly shown) so as to be mutually communicable through HTTP communication.

The client terminal 10 is an information equipment, such as a PC and a WS, including: a control section that has a CPU, a read only memory (ROM), a random access memory (RAM), and the like, which are not particularly shown, and controls the respective sections of the client terminal 10; a storage section, such as an optical/magnetic storage medium and a semiconductor memory, which stores a variety of pieces of data; an operation section that receives an operation input of a user from a keyboard, a mouse, or the like; a display section such as a cathode ray tube (CRT) and a liquid crystal display (LCD); and a communication interface communicably connected to an external equipment by a wire or wirelessly.

The client terminal 10 functions as a browser processing section 11 as a Web browser for a Web page (an HTML document), which displays, on the display section, a screen regarding a control and monitoring for an equipment connected to the controller, and receives an instruction from an operation button as an operation section displayed on the screen, in such a manner that the CPU expands a variety of application programs to a work area of the RAM and sequentially executes the expanded application programs.

The browser processing section 11 includes: a browser rendering section 12 that displays a screen which is based on a script language, such as JavaScript and ActionScript, conforming to the HTML, the XML and the European Computer Manufacturer Association (ECMA) Script, and on a program module such as the Applet; and a browser communication section 13 that requests data from the external equipment through an HTTP communication and receives an HTTP communication from the outside based on a selection of a link on the screen.

Note that, with regard to the Web page regarding the control and monitoring of the equipment connected to the controller 20, which is processed by the browser processing section 11, HTML data stored in the storage section of the client terminal 10 in advance may be read out, or the Web page may be a Web page acquired by designating a URL of an external Web server such as the controller 20.

The controller 20 includes a CPU, a RAM, a ROM, a storage section, a communication interface, and the like, which are not particularly shown. Then, the CPU expands, to a work area of the RAM, a variety of control programs stored in the ROM, and sequentially executes the expanded programs, whereby the controller 20 realizes functions as a control section 21 and a communication section 22.

The control section 21 controls the respective sections of the controller 20, monitors a sensor (not particularly shown) connected to the controller 20, and controls an open/close drive of a regulation valve (not particularly shown, either), or the like. The communication section 22 administers a data communication through the communication interface. Moreover, the communication section 22 communicates with the outside through the HTTP, and is constructed as at least a subset of the Web server. Note that, when the controller 20 has a sufficient resource, the communication section 22 may be constructed as a Web server of full-set.

Moreover, the communication section 22 includes: a CGI message interpretation section 23 that interprets the HTTP communication transmitted from the client terminal 10, and instructs the control section 21 to execute the programs related to the control and monitoring of the equipment; and an XML message generation section 24 that generates an XML message to be sent back to the client terminal 10 based on results of the control and the monitoring of the equipment by the control section 21.

Uniform resource locators (URL) are allocated in advance to control targets (the sensor and the regulation valve) for which it is possible to perform the control and the monitoring from the controller 20. For example, when the controller 20 collects a temperature and the like by using a plurality of the sensors, individual URLs are assigned to the respective sensors. In such a way, the instructions for the control/monitoring, which are issued to the control section 21 by the CGI interpretation section 23, are performed for the equipment that is based on the URL interpreted in the HTTP communication. Moreover, URLs may be allocated also to browsable information such as a log file and to a control command such as a collection start command.

Note that the control system 1 may be formed as a control system 1a including a controller 20a that intermediates a communication between a control device 30, an equipment management device 31, and a log management device 32, which are equipments as control targets shown in FIG. 1B, and the client terminal 10. Note that a communication between the client terminal 10 and a CGI message interpretation section 23a or a communication section 22a may be performed in a similar way to the above. Moreover, a communication between the CGI message interpretation section 23a or an XML message generation section 24a and the control device 30, the equipment management device 31, and the log management device 32 may be performed by either the HTTP communication or the dedicated protocol. In the control system 1a, the portal controller 20a can perform in a lump the control/monitoring for the respective control targets of the client terminal 10. Consequently, a user can individually control the devices while browsing the status of the entire system.

Here, the HTTP communication between the browser communication section 13 of the client terminal 10 and the communication section 22 and CGI message interpretation section 23 of the controller 20 will be described. The HTTP communication includes commands such as “GET”, “PUT”, “POST”, and “DELETE”. In the HTTP communication between the client terminal 10 and the controller 20, these commands are directly used as commands to the control targets of the controller 20, which are indicated by the URLs. Specifically, the URLs are individually allocated to the control targets connected to the controller 20, and the commands in the HTTP communication become the commands to the control targets.

“GET” is a command to collect the information of the control targets connected to the controller 20. For example, “GET” is used for acquiring a current value of a temperature sensor and a temperature history stored in the storage section. “PUT” is used when the control targets are made to perform some control processing such as executing the control command and changing a level of the log. Basically, the controller 20 is remotely controlled by these two types of commands.

“POST” is used when the URLs are assigned to the control targets of the controller 20. For example, “POST” is used in such a case where input/output (I/O) as a new control target is added to the controller 20, and a URL is remotely assigned to the new control target. Moreover, “DELETE” is used in such a case of erasing the log file as information regarding histories, which is stored in the storage section, and deleting the URL that has become useless.

In the case of using an argument in the above-described commands according to the HTTP communication, a method of designating a parameter, which is used in common CGI, is used. As a specific example, the CGI transmits the parameter in a format of “key=value”. When a plurality of the parameters are present, “&” is used as a separator.

Specifically, when the client terminal 10 performs the HTTP communication such as “GET http://xxx.xxx.xxx.xxx./hoge?pv” with the controller 20 of which IP address is “xxx.xxx.xxx.xxx”, “hoge” represents the control target, “GET” represents the command to the control target concerned, and “pv” represents a parameter in the command.

The control system 1 uses the above-described method using the HTTP communication, thus making it possible to perform parsing extremely easily in comparison with the SOAP or the like. Consequently, even when there are limitations on the resource of the controller 20, an influence from the CPU and the resource such as the memory can be suppressed, and the control processing as a main task of the controller 20 is not affected. Moreover, the HTTP communication and the CGI are used, whereby a versatile Web browser just needs to be activated without activating a dedicated application program on the client terminal 10 side.

Here, the processing in the control system 1, which is related to the control from the client terminal 10 for the equipment connected to the controller 20, will be described. Note that, since details of the processing are substantially the same among the commands according to the HTTP communication, the processing will be described while illustrating processing using the “GET” command of the HTTP communication, which is to acquire the information.

As shown in FIG. 2, in the client terminal 10, the browser rendering section 12 outputs, to the browser communication section 13, a rendering update (data update) request of the browser, which is related to a predetermined equipment and made by a selection of a link from the operation section or by an execution of the script language, the program module, or the like (Step S11). Note that, for the rendering update in Step S11, Asynchronous JavaScript+XML (AJAX) that requests the XML message without reloading the page through the HTTP communication function of JavaScript may be used. Through the HTTP communication, the browser communication section 13 outputs the instruction (for example, “GET http://xxx.xxx.xxx.xxx./hoge?pv”) to request the latest data of the predetermined equipment from the controller 20 based on the instruction from the browser rendering section 12 (Step S12).

Subsequently, in the controller 20, based on the instruction from the client terminal 10 through the HTTP communication, the CGI interpretation section 23 extracts the command (“GET”), the control target (“hoge’), and the parameter (“pv”), and outputs these pieces of information regarding the equipment to the control section 21 (Step S13). The control section 21 acquires the information regarding the equipment, which is outputted from the CGI message interpretation section 23, by designating the parameters and the like, and outputs the information to the XML message generation section 24 (Step S14). The XML message generation section 24 converts the information regarding the equipment, which is acquired by the control section 21, into an XML, and outputs the XML to the client terminal 10 through the HTTP communication (Step S15).

Subsequently, in the client terminal 10, the browser communication section 13 extracts the information regarding the equipment from the XML transmitted from the controller 20, and outputs the information to the browser rendering section 12 (Step S16). Then, based on the information, the browser rendering section 12 updates the rendering, and updates the data regarding the equipment (Step S17).

As described above, the control system 1 is composed so as to perform, through the HTTP communication, the communication between the client terminal 10 that remotely performs the operation instruction and the controller 20 related to the control/monitoring of the equipment, to pass the instruction, which goes from the client terminal 10 to the controller 20, through the CGI message interpretation section 23, and to perform, as the XML message, the output of the data such as the monitoring information of the equipment, which goes from the controller 20 to the client terminal 10.

Consequently, it is not necessary for the control system 1 to perform processing, such as the parsing for the XML, excessively consuming the resource in the event of analyzing the instruction from the client terminal 10. Moreover, the control system 1 uses the XML message in which a quantity of the data from the controller 20 to the client terminal 10 is not redundant like the SOAP, and Consequently, traffic can be suppressed. Furthermore, the control system 1 can directly use security techniques, which is used in the Web, for the communication between the client terminal 10 and the controller 20, and the control system 1 can be constructed of a highly versatile communication configuration.

Moreover, the control system 1 instructs, which goes from the client terminal 10 to the controller 20, by the HTTP commands such as “GET” and “PUT” in the HTTP communication. Consequently, the control system 1 can allow the CGI message interpretation section 23 to easily interpret the CGI message, and can suppress the resource consumption in the controller 20.

Furthermore, the control system 1 allows the browser rendering section 12 to perform the rendering on the display section based on the script language of the HTML document, which is processed by the browser processing section 11 of the client terminal 10, and on the program module. Consequently, the control system 1 can perform the rendering, for example, using the AJAX that does not cause page transition by the scrip language and the program module, and can suppress flicker of the screen when the information of the equipment monitored by the client terminal 10 is updated.

Note that the description of this embodiment merely illustrates an example of the present invention, and the present invention is not limited to the description. It is possible to appropriately change the detailed configurations and operations of the control system 1 in the present invention within the scope without departing from the spirit of the present invention.

The entire disclosure of Japanese Patent Application No. 2006-167317 filed on Jun. 16, 2006, including description, claims, drawings and summary are incorporated herein by reference in its entirety.

What is claimed is:

1. A control system comprising:
a controller to control an equipment connected thereto and/or to output monitoring information of the equipment based on an inputted control instruction; and
a client terminal to control the equipment connected to the controller by outputting the control instruction to the controller and/or to monitor the equipment connected to the controller based on the monitoring information outputted from the controller, the client terminal being communicably connected to the controller,
wherein the client terminal includes:
a Web browser processing section to perform a communication with the controller through an HTTP communication, the communication being related to the control and/or monitoring of the equipment, and
the controller includes:
a CGI message interpretation section to output the control instruction for the equipment and/or an output instruction for the monitoring information to a control section which controls and/or monitors the equipment, the control instruction and the output instruction being included in the HTTP communication from the client terminal; and
an XML message generation section to generate an XML message including the monitoring information of the equipment, the monitoring information being acquired by the control section, and to output the XML message to the client terminal through the HTTP communication.

2. The control system according to claim 1,
wherein the Web browser processing section of the client terminal issues, as an HTTP command, the communication related to the control and/or the monitoring of the equipment in the HTTP communication with the controller, and
the CGI message interpretation section of the controller outputs the control instruction for the equipment and/or the output instruction for the monitoring information to the control section, based on the HTTP command.

3. The control system according to claim 1,
wherein the Web browser processing section of the client terminal includes a Web browser communication section, and a Web browser rendering section,
the Web browser communication section performs the HTTP communication with the controller, and
the Web browser rendering section renders, on a display section, an image based on an HTML document related to the control and/or monitoring of the equipment and/or on the XML message from the controller, the XML message being received by the browser communication section.

4. The control system according to claim 3,
wherein, based on a script language of the HTML document and/or on a program module, the Web browser rendering section of the client terminal instructs the controller to output the XML message so that the XML message is acquired through the Web browser communication section.
